(19) United States
(12) Patent Application Publication
(10) Pub. No.: US 2007/0270126 A1
(43) Pub. Date: Nov. 22, 2007

(54) Authentication of a digital voice conversation

(75) Inventors: Scott C. Forbes, Redmond, WA (US); David Milstein, Redmond, WA (US); Linda Criddle, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/437,596

(22) Filed: May 18, 2006

(51) Int. Cl. H04M 1/66

(52) U.S. Cl. 455/411

(57) ABSTRACT

Generally described, the present invention relates to a method and system that provides the ability to digitally sign or authenticate a digital conversation and provides the ability to enable another entity to act on someone's behalf. More specifically, in some instances, digital conversations may be stored (e.g., for legal and/or medical purposes) and the authenticity of those digital conversations may be critical. Embodiments of the present invention provide the ability for the parties involved in the digital conversation to authenticate and associate themselves with the conversation and that authentication may be integrated or bound with the digital conversation.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, its ability to establish and control multimedia communication, and the like. VoIP technology will likely continue to gain favor because of its ability to provide enhanced calling features and advanced services which traditional telephony technology has not been able to provide. However, current VoIP approaches do not provide the ability for individuals to digitally sign or authenticate the communication. Additionally, current VoIP approaches do not provide the ability for an individual to empower another individual or entity to act on their behalf.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with at least one aspect of the present invention, a method for authenticating a contact point that is participating in a digital voice communication is provided. The method includes receiving an authentication request for a contact point and obtaining authentication of that contact point. For example, authentication of a contact point may be obtained through the use of biometrics (e.g., voice recognition), passwords, digital signatures, etc. A received authentication is used to confirm the identity of the contact point and provide authentication information for the contact point. The authentication information may be the received authentication or any other information that confirms the identity of the contact point.

In accordance with another aspect of the present invention, a computer-readable medium having computer-executable components for authenticating contact points and digital voice conversations is provided. The computer-readable medium includes an authentication request component, an authentication collection component, an authentication application component, and optionally an authentication validation component. The authentication request component is configured to generate authentication requests that are issued to at least one contact point involved in a digital voice conversation. The authentication collection component collects authentication from at least one contact point involved in a digital voice conversation. The authentication application component applies the collected authentication(s) to the digital voice communication associated with the request and collection component. In one example, applying the collected authentication(s) includes binding the collected authentication(s) with data packets of the digital voice conversation. The authentication validation component is configured to validate the collected authentication(s) to ensure that they are appropriate for the conversation and/or for verifying the integrity of the authentication.

In accordance with yet another aspect of the present invention, a method for generating an authenticated conversation is provided. The method includes receiving authentication information from at least one contact point involved in a digital voice conversation, collecting a plurality of data packets from the digital voice conversation, and binding the received authentication information with the plurality of data packets to generate an authenticated conversation.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A and 7B are block diagrams illustrative of interactions among VoIP entities in the VoIP environment utilizing authentication in accordance with an embodiment of the present invention;

FIGS. 8-12 are block diagrams illustrative of various attributes and classes of structured hierarchies corresponding to VoIP contextual information in accordance with an aspect of the present invention;

FIG. 13 is a flow diagram of an authentication routine for authenticating a contact point in accordance with an embodiment of the present invention;

FIG. 14 is a flow diagram of a third-party authentication subroutine for obtaining authentication from a third-party to be used in connection with authentication of an existing digital voice conversation in accordance with an embodiment of the present invention; and

FIG. 15 is a flow diagram of an authentication application routine for applying received authentication information in accordance with an embodiment of the present invention.

### DETAILED DESCRIPTION

Generally described, the present invention relates to a method and system that provides the ability to digitally sign or authenticate a digital conversation and provides the ability to enable another entity to act on someone's behalf. More specifically, in some instances, digital conversations may be stored (e.g., for legal and/or medical purposes) and the authenticity of those digital conversations may be critical. Embodiments of the present invention provide the ability for the parties involved in the digital conversation to authenticate and associate themselves with the conversation and that authentication may be integrated or bound with the digital conversation. Additionally, in some instances it may be desirable to empower another entity with the authority to act on someone's behalf. For example, a doctor may desire to empower his/her nurse (delegate authority) with the ability to authenticate a digital conversation requesting prescription drugs on his/her behalf. Embodiments of the present invention provide the ability to authorize another entity to act on someone's behalf.

Authentication information may be exchanged as part of contextual information represented in accordance with “structured hierarchies.” “Structured hierarchies,” as used herein, are predefined organizational structures for arranging contextual information to be exchanged between two or more VoIP devices. For example, structured hierarchies may be XML namespaces. Further, a VoIP conversation is a data stream of information related to a conversation, such as contextual information and voice information, exchanged over a conversation channel. Although the present invention will be described with relation to illustrative structured hierarchies and an illustrative IP telephony environment, one skilled in the relevant art will appreciate that the disclosed embodiments are illustrative in nature and should not be construed as limiting.

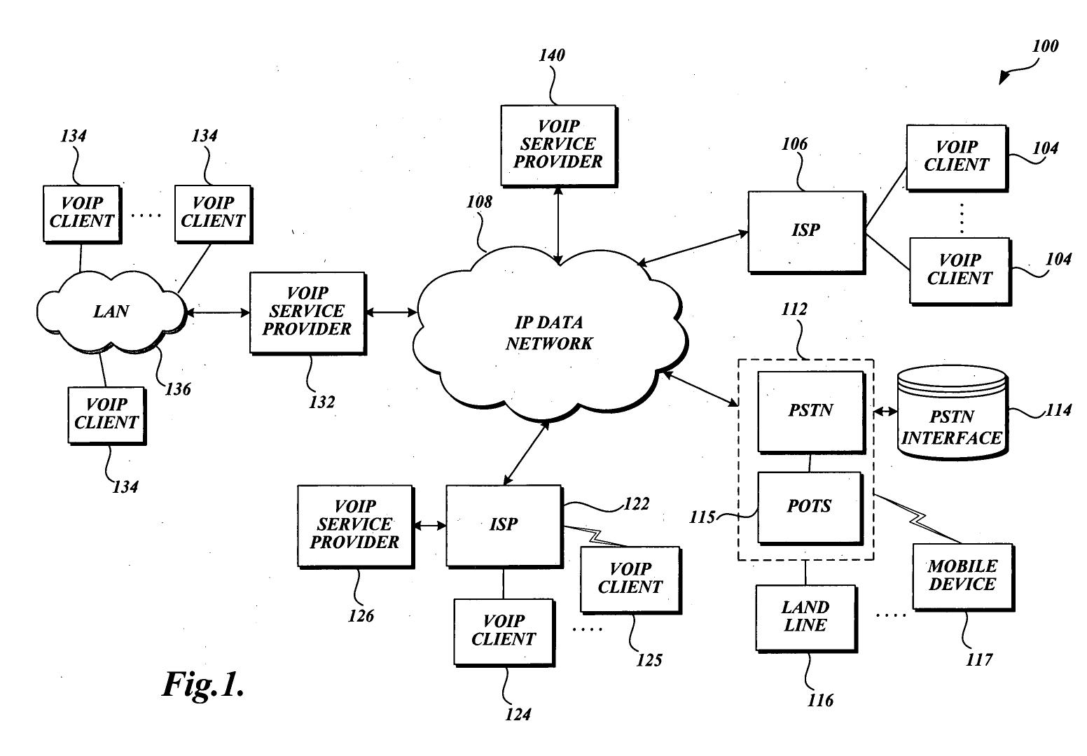

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices, and a unique VoIP client identifier. For example, a single individual, five associated VoIP devices, and a unique VoIP client identifier collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108, such as the Internet, an intranet network, a wide area network (WAN), a local area network (LAN) and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third-party VoIP service providers 140. The VoIP service providers 126, 132, 140 may provide various calling features, such as incoming call-filtering, text data, voice and media data integration, and integrated data transmission as part of a VoIP call conversation. VoIP clients 104, 124, 125, 136 may create, maintain, and provide information relating to predetermined priorities for incoming calls. In addition, the VoIP service providers 126, 132, 140 may also generate, maintain, and provide a separate set of priority information (e.g., provider priority list) for individuals communicating in a call conversation. The VoIP service providers 126, 132, 140 may determine and assign an appropriate priority level to data packets based on priority information provided by VoIP clients 104, 124, 125, 136 in conjunction with the provider priority list.

VoIP service providers 132 may be coupled to a private network, such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services (e.g., authentication) for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 communicatively connected to a PSTN 112. A PSTN interface 114, such as a PSTN gateway, may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116, may request a connection with the VoIP client based on the unique VoIP identifier of that client and the appropriate VoIP device associated with the VoIP client will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client and any of the entities (VoIP clients, client devices, service providers, ISPs) may perform authentication of individuals and/or conversations.

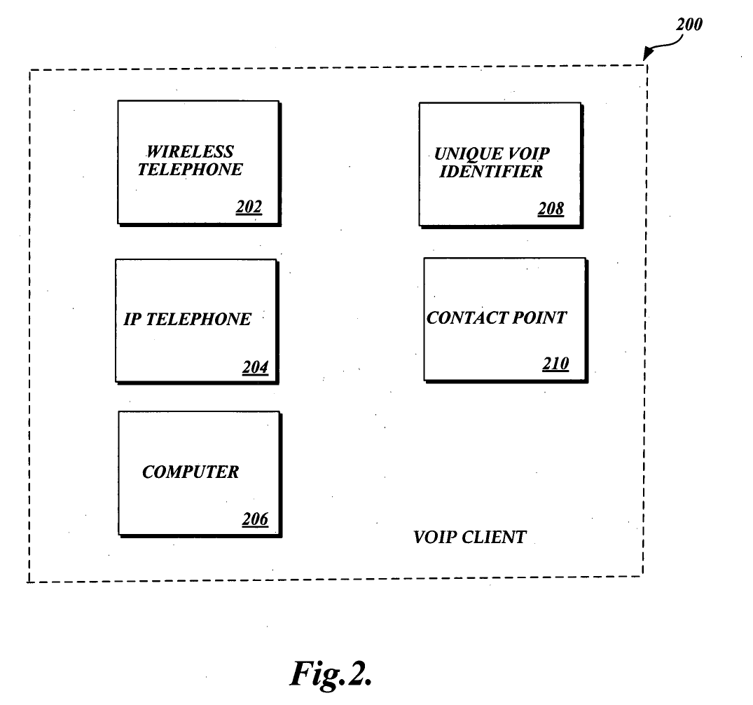

Referring now to FIG. 2, a block diagram illustrating an exemplary VoIP client 200 that includes several VoIP devices and a unique VoIP identifier in accordance with an embodiment of the present invention is shown. Each VoIP device 202, 204, 206 may include a storage that is used to maintain voice messages, address books, client specified rules, priority information related to incoming calls, etc. Alternatively, or in addition thereto, a separate storage, maintained, for example, by a service provider, may be associated with the VoIP client and accessible by each VoIP device that contains information relating to the VoIP client. In one embodiment, any suitable VoIP device, such as a wireless phone 202, an IP phone 204, or a computer 206 with proper VoIP applications, may be part of the VoIP client 200. The VoIP client 200 also maintains one or more unique VoIP identifier 208. The unique VoIP identifier(s) 208 may be constant or change over time. For example, the unique identifier(s) 208 may change with each call. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In alternative embodiments, the VoIP client 200 may maintain multiple VoIP identifiers. In this embodiment, a unique VoIP identifier may be temporarily assigned to the VoIP client 200 for each call session.

The unique VoIP identifier may be used similar to a telephone number in PSTN. However, instead of dialing a typical telephone number to ring a specific PSTN device, such as a home phone, the unique VoIP identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

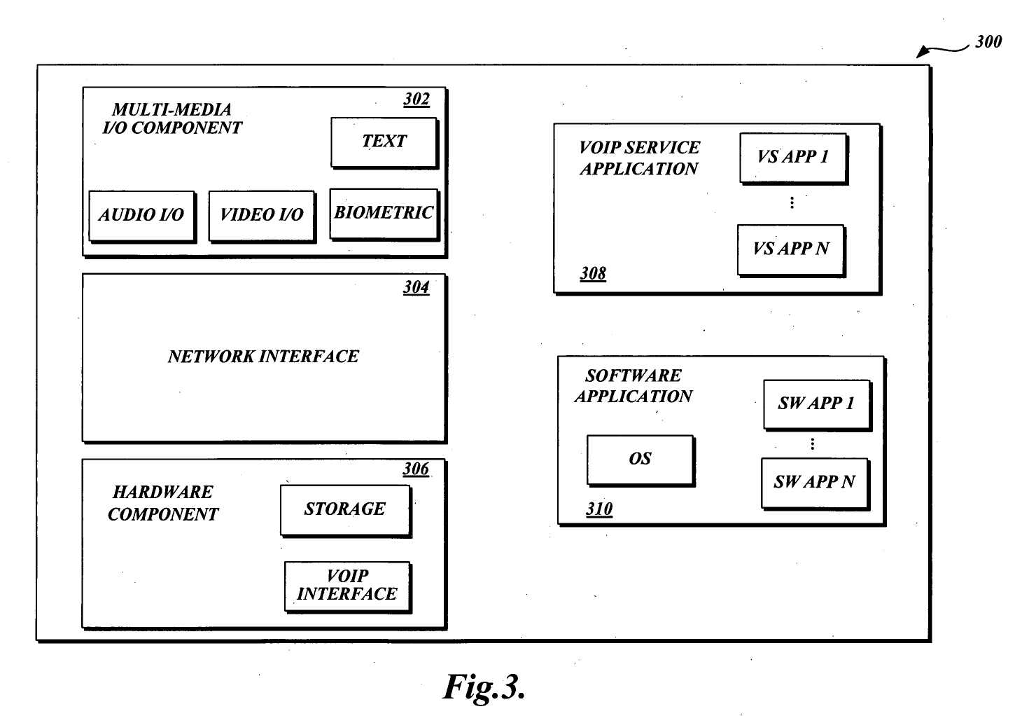

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting, and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components, such as a microphone, a video camera, a display screen, a keyboard, user biometric recognition devices, and the like. The multimedia input/output component 302 may also receive and transmit multimedia data via the network interface component 304. The network interface component 304 may support interfaces, such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage, such as read-only memory devices (ROM), random access memory (RAM), hard drives, optical drives, and the like. The storage may be configured to store program instructions for controlling the operation of an operating system and/or one or more applications and to store contextual information related to individuals (e.g., user biometrics information, such as a voice template, etc.) associated with the VoIP client in which the device is included. In one embodiment, the hardware component 306 may include a VoIP interface which allows a non-VoIP client device to transmit and receive a VoIP conversation.

The device 300 may further include a software application component 310 for the operation of the device 300 and a VoIP Service application component 308 for supporting various VoIP services. The VoIP service application component 308 may include applications, such as data packet assembler/disassembler applications, a structured hierarchy parsing application, audio Coder/Decoder (CODEC), video CODEC, and other suitable applications for providing VoIP services.

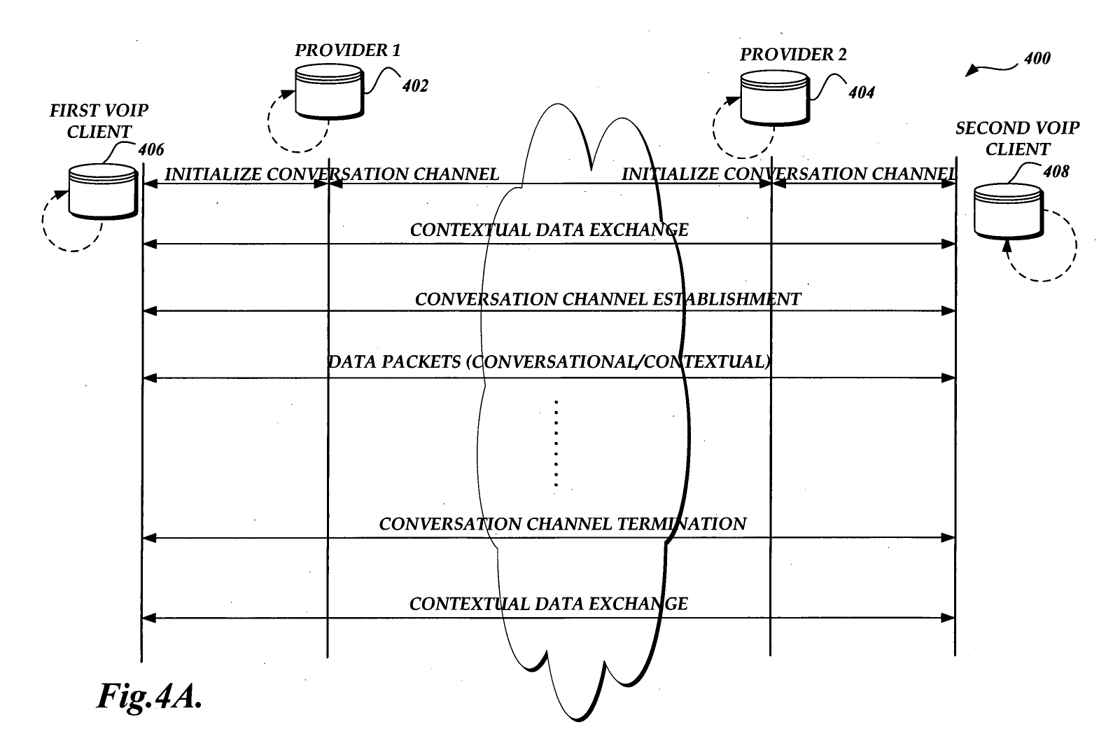

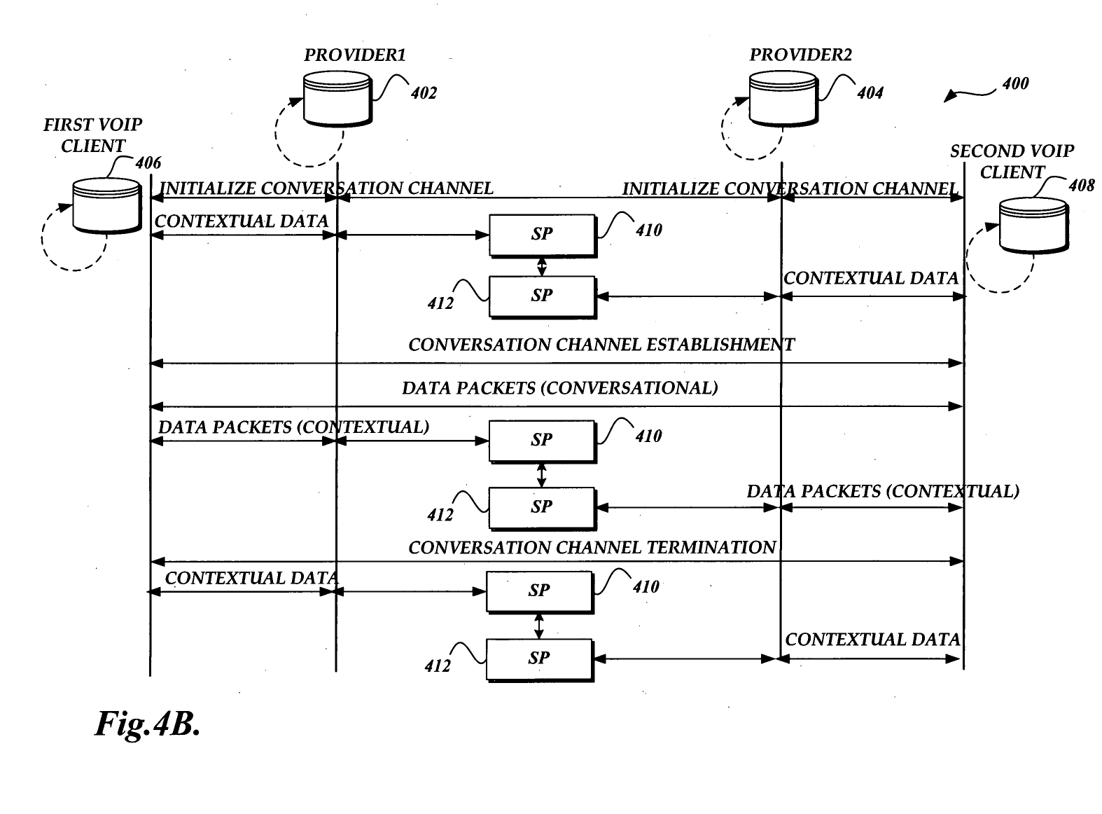

With reference to FIG. 4A, a block diagram illustrative of a conversation flow 400 between VoIP devices of two different VoIP clients over a conversation channel in accordance with an embodiment of the present invention is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only includes one VoIP device. Accordingly, the discussion provided herein will refer to connection of the two VoIP devices. The individual using the device of the first VoIP client 406 may select or enter the unique VoIP identifier of the client that is to be called. Provider 1 402 receives the request from the device of the first VoIP client 408 and determines a terminating service provider (e.g., Provider 2 404 of the second VoIP client 408) based on the unique VoIP identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged and the contact points (e.g., individuals, companies, etc.) using the devices may be authenticated. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. Moreover, the type or level of authentication required may be determined based on the conversation content and specified by any one or more of a client device, service provider of a client, or a third-party service provider. Additionally, the necessary authentication type or level may change during a conversation.

Available media types, rules of the calling client and the client being called, and the like, may also be part of the contextual information that is exchanged during the connection set-up phase. The contextual information may be processed and collected by one of the devices of the first VoIP client 406, one of the devices of the second VoIP client 408, and/or by VoIP service providers (e.g., Provider 1 402 and Provider 2 404) depending on the nature of the contextual information. In one embodiment, the VoIP service providers 402, 404 may add/or delete some information to/from the client's contextual information before forwarding the contextual information.

In response to a request to initiate a conversation channel, the second VoIP client 408 may accept the request for establishing a conversation channel or execute other appropriate actions, such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider1) for the first VoIP client 406 receives the request to initiate a conversation channel and forwards the request to a VoIP service provider 404 (Provider2) for the second VoIP client 408.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, the VoIP service providers (e.g., Provider1 and Provider2), or a third-party service, depending on the nature of the contextual information. For example, authentication of the contact points using the client devices may be collected by the service providers 402, 404 and only temporarily provided to the devices. Authentication of a contact point may be obtained in a variety of ways. For example, a contact point may be authenticated using voice recognition, biometrics, passwords, smartcard, etc. Any type of authentication techniques may be used with embodiments of the present invention. Additionally, authentication may be obtained at initiation of the conversation or at a prior point-in-time (e.g., power-on of the device) and/or during the conversation. Further, third-party Service Provider(s) (third-party SP) 410, 412 can obtain and/or add contextual information exchanged among devices of the first VoIP client 406 and second VoIP client 408, Provider 1 402, and Provider 2 404. In one embodiment, any of Provider 1 402, Provider 2 404, and third-party SP 410, 412 may add, modify, and/or delete contextual information before forwarding the contextual information to the next VoIP device(s), including other service providers.

In response to a request to initiate a conversation channel, the second VoIP client 408 may accept the request for establishing a conversation channel or reject the request via Provider 2 404. For example, the client 406 may accept the request upon identification of the calling client based on the received authentication information. In addition, the second client 408 may provide to the first client 406 authentication information. When a conversation channel has been established, the devices of the first VoIP client 406 and the second VoIP client 408 start communicating with each other by exchanging data packets as discussed above. In one embodiment, contextual and/or conversation data packets may be forwarded to third-party SPs 410, 412 from Provider 1 402, Provider 2 404, or from either VoIP client 406, 408. Further, the forwarded contextual and/or conversation data packets may be exchanged among various third-party SPs 410, 412.

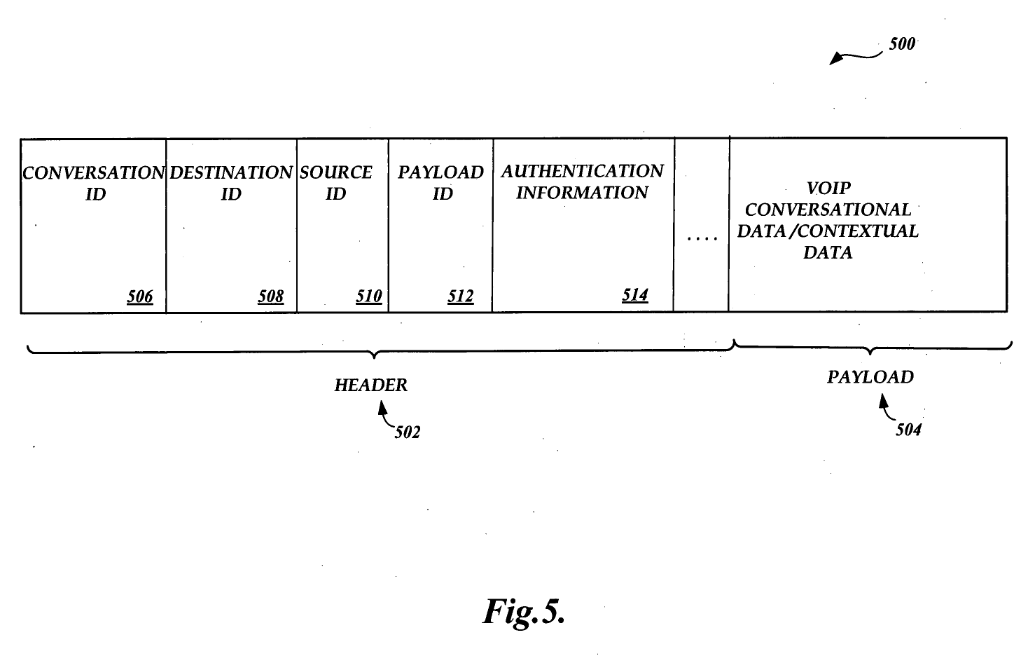

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include a conversation ID 506 for identifying a conversation (e.g., call), a Destination ID 508, such as a unique VoIP identifier of the client being called, a Source ID 510 (unique VoIP identifier of the calling client or device identifier), a Payload ID 512 for identifying type of payload (e.g., conversation or contextual), an individual ID (not shown) for identifying the individual for which the conversation data is related, authentication information 514 for providing authentication of clients, and the like. In an alternative embodiment, the header 502 may contain information regarding Internet protocol versions and payload length, among others. The payload 504 may include conversational or contextual data relating to an identified conversation. As will be appreciated by one of ordinary skill in the art, additional headers may be used for upper layer headers, such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client authentication, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify, and/or delete VoIP client's contextual data before forwarding the contextual information. For example, if client authentication is being performed by a third-party service provider, it may receive authentication information, confirm the authenticity, replace the authentication information with an authentication confirmation, and forward the contextual information to a receiving client.

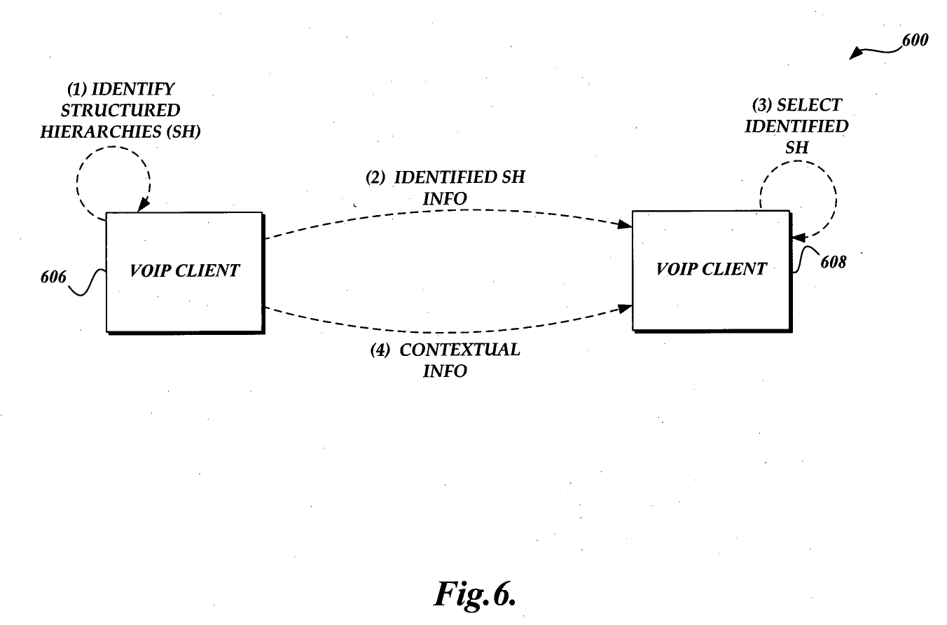

With reference to FIG. 6, a block diagram 600 illustrating interactions between two VoIP clients for transferring contextual information in accordance with an embodiment of the present invention is shown. As with FIGS. 4A and 4B, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information about which structured hierarchy is used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated, thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

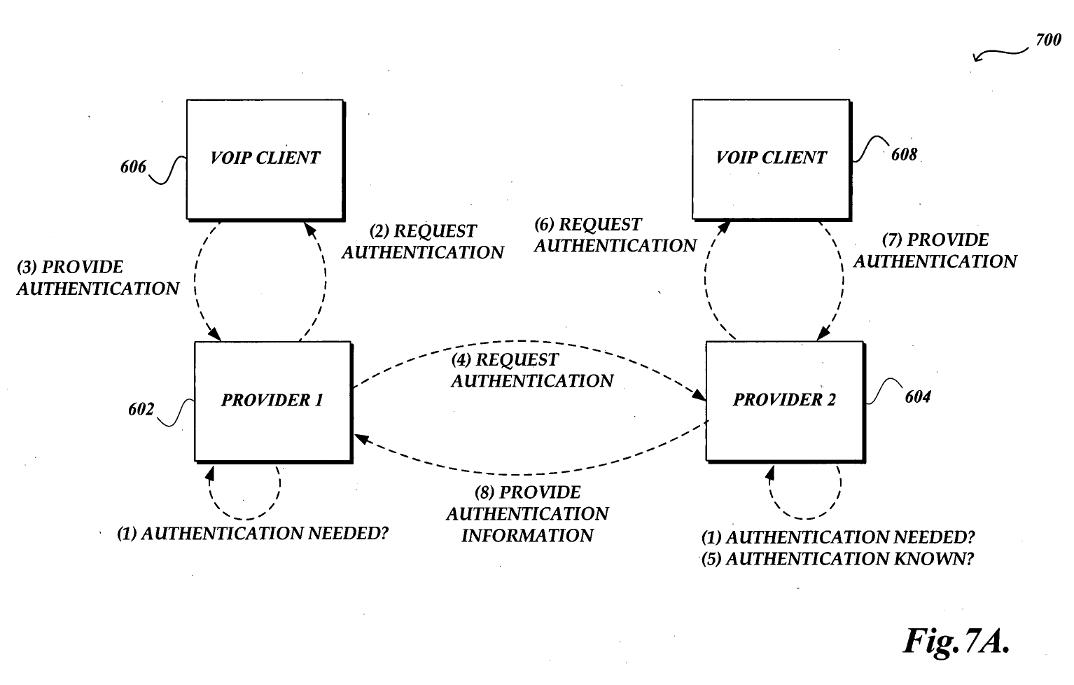

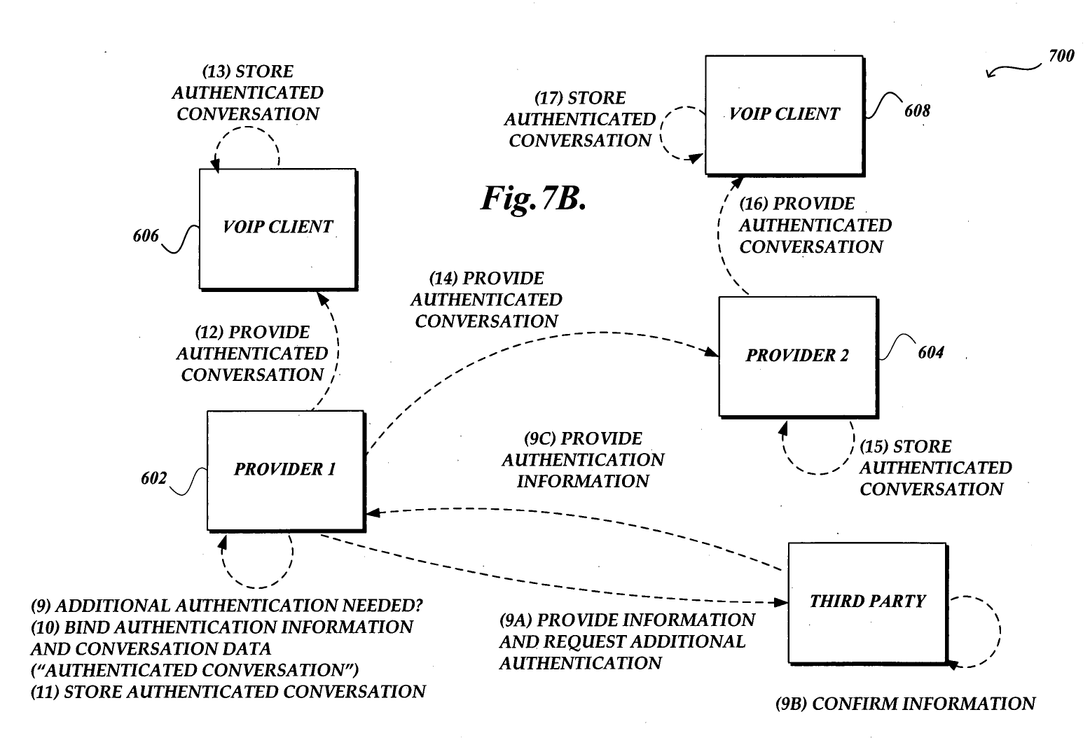

FIGS. 7A and 7B are block diagrams 700 illustrating interactions among VoIP entities in the VoIP environment utilizing authentication in accordance with an aspect of the present invention. In one embodiment, the VoIP entities may include VoIP clients, VoIP service providers for the clients, third-party service providers, and the like. It is to be noted that one of ordinary skill in the relevant art will appreciate that any suitable entities may be included in the IP telephone environment.

With reference to FIG. 7A, in one embodiment, VoIP Client 606 may already have an existing communication channel with VoIP Client 608. While this example utilizes two VoIP service providers and two VoIP clients (and an optional third-party service provider), any number and combination of VoIP clients and/or service providers may be used with embodiments of the present invention.

During the conversation, any one of the entities may be checking to determine if authentication is needed. In one embodiment, authentication may periodically occur during the conversation to ensure that no changes in the contact points involved in the conversation have unknowingly occurred. For example, Provider 1 602 may periodically issue an authentication request. In addition to periodic checking, one of the entities may determine that authentication is required based on, for example, the conversation, input from one of the contact points in response to an action from an automated system, addition of new media (e.g., video images), etc. For example, if during a conversation one of the clients attempts to transmit explicit content (e.g., video) to another client, one of the entities may determine that authentication of the receiving entity is needed to determine if the receiving entity is allowed to receive such material. In the example illustrated in FIG. 7A, we will discuss the example in which Provider 1 602 determines that authentication is needed.

Upon determining that authentication is needed, Provider 1 602 requests authentication from the VoIP Client 606. The VoIP Client 606, upon receiving an authentication request, generates authentication information for the contact point using the VoIP Client 606 devices. Authentication may be obtained using any type of authentication technique including, but not limited to, biometrics, passwords, public/private keys, digital signatures, etc. Authentication information may be provided in any form that is verifiable and that identifies the user(s). For example, authentication may be provided in the form of a digital signature, biometric information, etc. Moreover, the obtained authentication and the authentication information provided need not be the same. For example, if the VoIP client device is only capable of obtaining authentication via voice recognition but the authentication information that is to be exchanged as part of the conversation is a digital signature, the VoIP Client 606 may authenticate the user through voice recognition, obtain a digital signature associated with the voice, and provide the digital signature as the authentication information.

The VoIP Client 606 may have previously obtained authentication of the user(s) and generated authentication information and may provide that authentication information in response. Alternatively, or in addition thereto, the VoIP Client 606 may, in response to the authentication request, obtain authentication of the user(s) and generate authentication information in real-time. Upon generation of authentication information, the VoIP Client 606 provides that information to Provider 1 602.

In addition to requesting authentication information from VoIP Client 606, Provider 1 602 sends an authentication request to VoIP Client 608, via Provider 2 604. Provider 2 604, upon receipt of an authentication request may automatically forward the request to the VoIP Client 608 or may determine if it already maintains the necessary authentication information for Client 608. In addition, if Provider 2 604 periodically issues authentication requests, receipt of an authentication request may restart the time-period before Provider 2 604 issues an authentication request.

Assuming Provider 2 604 does not have the necessary authentication information for Client 608, or if the authentication information is not current, Provider 2 604 forwards the authentication request to Client 608. Client 608, similar to Client 606, determines if it already has authentication information for the user(s) and may provide that information in response. Alternatively, or in addition thereto, the VoIP Client 608 may, in response to the authentication request, obtain authentication of the user(s) and generate authentication information for the user(s). Upon generation of authentication information, the VoIP Client 608 provides that information to Provider 2 604. Provider 2 604 may store a copy of the received authentication information, along with a timestamp identifying when the information was obtained, and forward the authentication information to Provider 1 602.

Referring now to FIG. 7B, Provider 1 602 may determine that additional authentication is necessary. If the authentication is simply user authentication that periodically occurs, additional authentication may not be necessary. However, if the authentication is for a specific purpose and may be bound to the conversation, additional authentication may be necessary. For example, if a contact point (e.g., an individual) using Client 606 is placing an order to buy a car, additional authentication may be necessary from the bank that will be carrying the loan for the car. Activities where additional authentication may be necessary are numerous and it will be appreciated that any activity that requires additional authentication may be used with embodiments of the present invention. As a general guide, additional authentication using embodiments of the present invention may be used in activities that if typically occurring, would require an individual to appear in person, obtain notarization, obtain a witness signature, or the like.

If it is determined that additional authentication is needed, Provider 1 602 may contact the necessary source for obtaining the additional authentication. For example, the additional authentication may be obtained from one or more third-parties, such as a parent, a bank, or other service provider. Alternatively, the additional authentication may be obtained from one or more of the entities involved in the conversation (e.g., VoIP Client 606, Provider 2 604, etc.). Moreover, as discussed below, one of the devices of the conversation may have already obtained the necessary authentication information (via delegation) that is necessary to confirm and complete the activity. For example, if the activity is the ordering of a prescription drug and the user of VoIP Client 606 is a nurse, or an automated system, the nurse/system may have already obtained, via delegation, the prescribing doctor's authentication information necessary for ordering the prescription drugs.

Returning to the example of FIG. 7A, once the third-party is contacted, it confirms the necessary material, such as the context of the conversation and the activity that is being completed and provides the additional authentication that is requested.

Upon receipt of all the necessary authentication information, if the conversation, or a portion thereof, is to be bound with the authentication information, Provider 1 602 binds the authentication information with the conversation to associate the authentication information with the conversation. Binding may be accomplished by encoding the conversation with the authentication information or through other techniques for associating information. The conversation and bound authentication information is referred to herein as an “authenticated conversation.” The authenticated conversation may be used to verify an activity and/or to verify who participated in a conversation or conducted the activity. Returning to the example of purchasing a car, the conversation between the contact point (“Bob”) and the car dealership (“Car Dealer”) wherein: (1) Bob explains that he wants a Blue 2004 BMW 545i that is in good shape; (2) the Car Dealer states that they have such a car, that it only has 3,000 miles, and that it is available for $50,000; and (3) Bob acknowledges that he will buy the car for $50,000, may be bound with the authentication information of Bob, the Car Dealer, and the loan company that provides the additional authentication that they will carry the loan on the car to create an authenticated conversation. This authenticated conversation may be saved and used at a later point in time to verify the transaction and, if necessary, prove what each party agreed to and/or stated. The authenticated conversation may be provided to each of the entities involved in the transaction for storage and/or may be stored by Provider 1 602.

In exchanging the authentication requests, the authentication information, and the authenticated conversation, the data packets carrying that information may be defined, as described above, according to structured hierarchies. Further, the information regarding the identified structured hierarchies may be transmitted. The information regarding the identified structured hierarchies may include the information about which structured hierarchies carry the authentication information (part of the contextual information), how to identify the structured hierarchies, and the like. Subsequently, the contextual information corresponding to authentication information may be represented in accordance with the identified structured hierarchies and transmitted.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software, and hardware independent tool for transmitting information. Further, XML maintains its data as a hierarchically-structured tree of nodes, each node comprising a tag that may contain descriptive attributes. Typically, an XML namespace is provided to give the namespace a unique name. In some instances, the namespace may be used as a pointer to a centralized location containing default information about the namespace.

In an illustrative embodiment, VoIP Client 606 may identify an XML namespace for contextual information. For example, the XML namespace attribute may be placed in the start tag of a sending element. It is to be understood that XML namespaces, attributes, and classes illustrated herein are provided merely as an example of structured hierarchies used in conjunction with various embodiments of the present invention. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information.

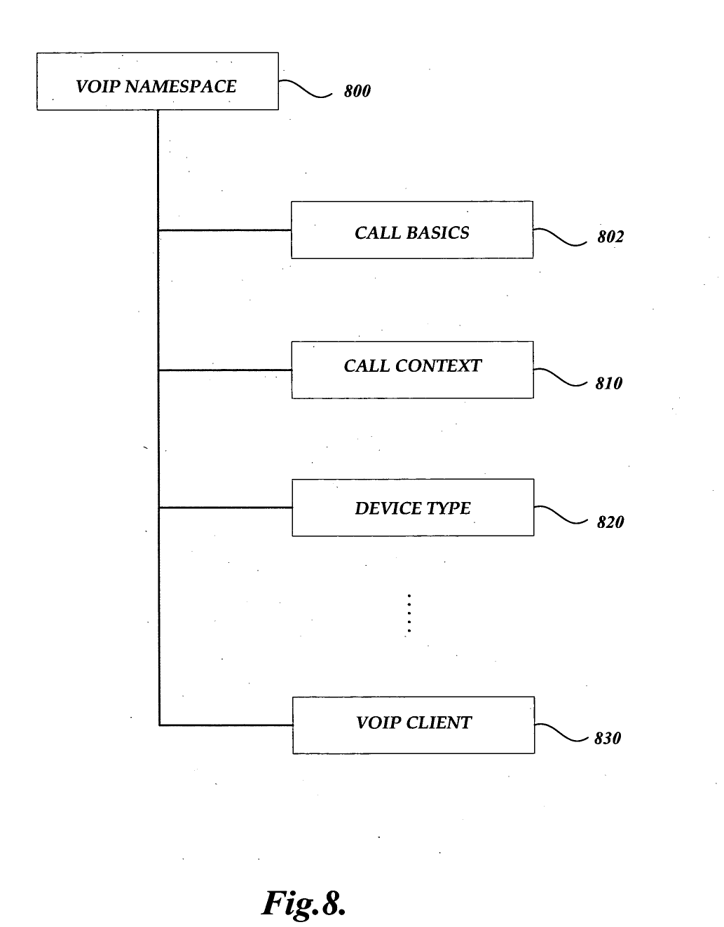

With reference to FIGS. 8-12, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830, and the like.

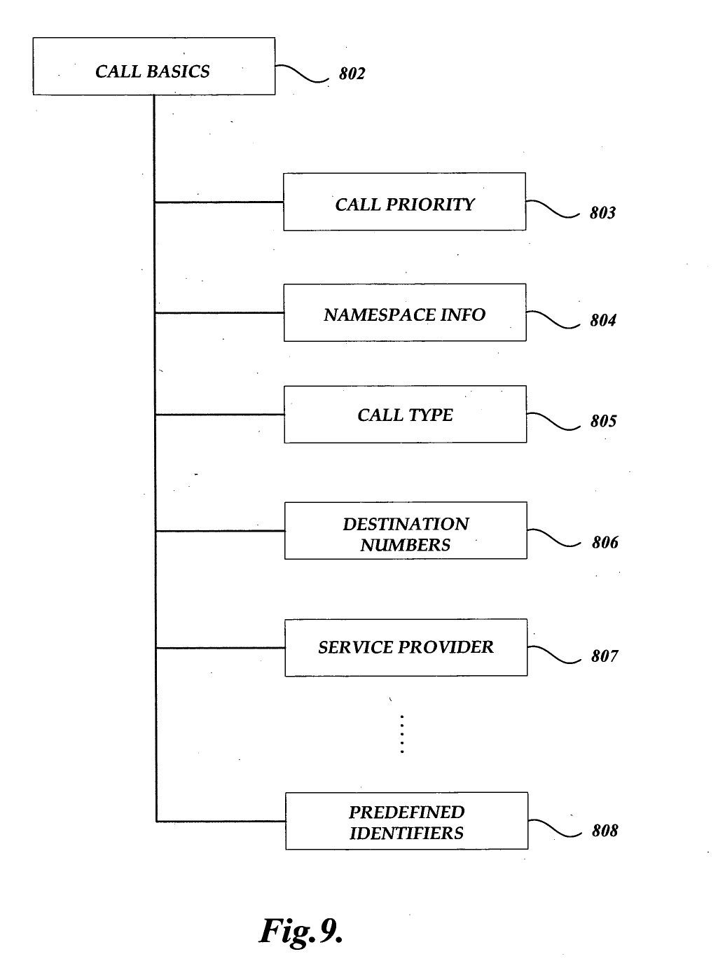

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, permissions and restrictions, and the like). The subset of the VoIP contextual information relating to a conversation channel connection may include originating numbers (e.g., a caller's VoIP ID number), destination numbers (e.g., callees' VoIP ID numbers or telephone numbers), call connection time, VoIP service provider related information, and/or ISP related information, such as IP address, MAC address, namespace information, and the like. Additionally, the contextual information relating to a conversation channel connection may include call type information and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah,” “oops,” “wow,” etc.), and facial expressions in graphical symbols. In one embodiment, a Call Basics Class 802 may be defined as a sub-tree structure of a VoIP Namespace 800, which includes nodes, such as call priority 803, namespace information 804, call type 805, destination numbers 806, service provider 807, predefined identifiers 808, and the like.

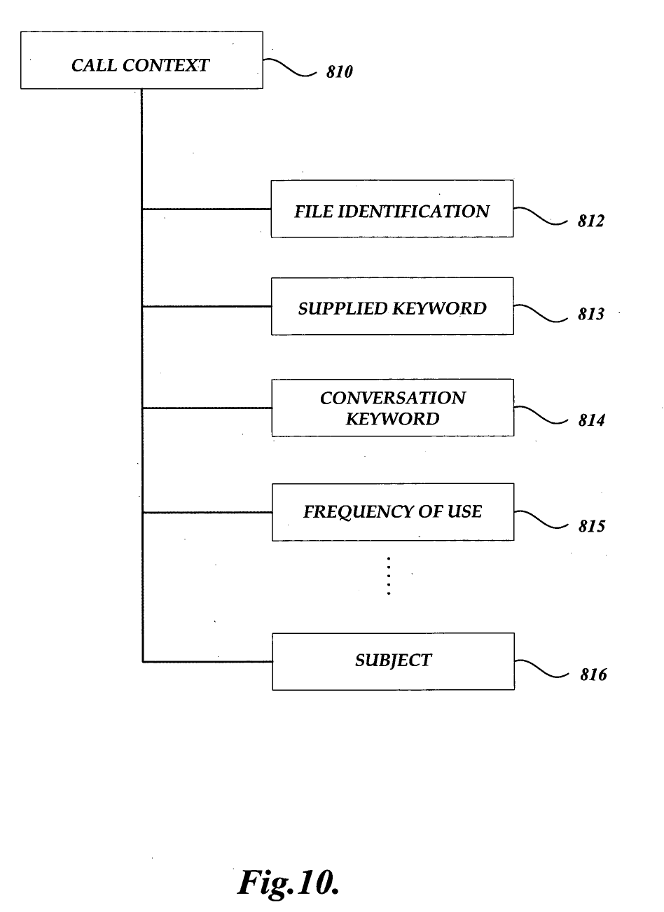

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information, such as supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

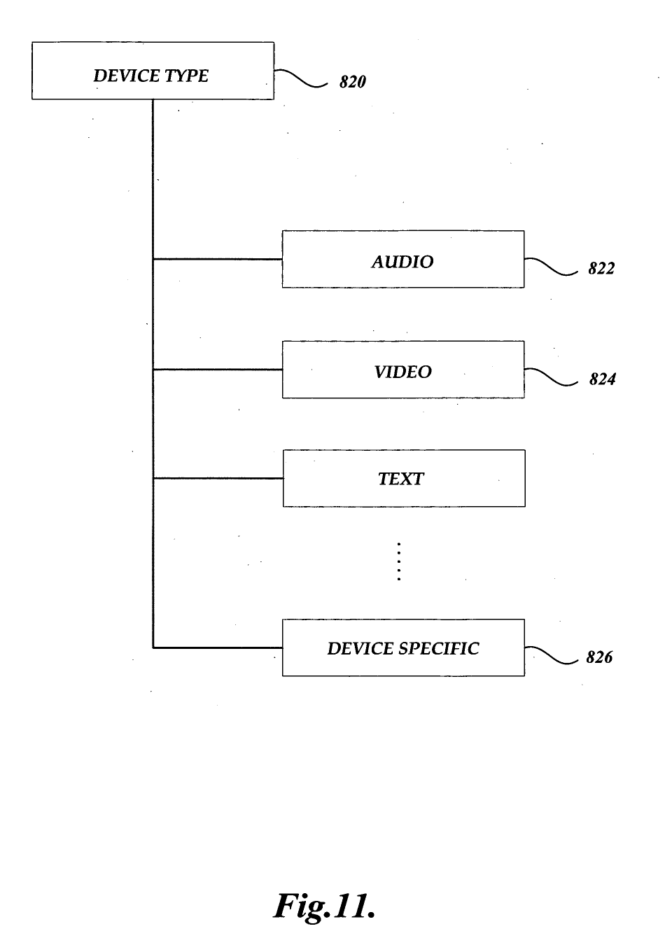

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type, and size of the video data, graphic card information, and the like. The contextual information relating to VoIP client devices may further include other device specific information, such as a type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826, and the like.

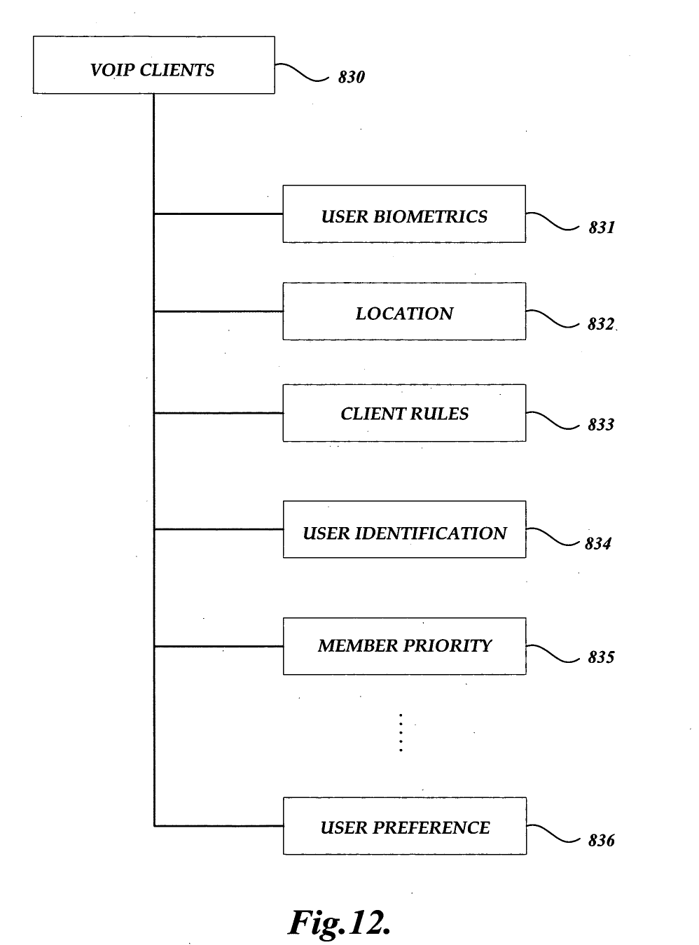

With reference to FIG. 12, a block diagram of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include authentication information, such as digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a sub-tree structure of a VoIP Namespace 800, which includes nodes corresponding to user biometrics 831, location 832, client rules 833, user identification 834, member priority 835, user preference 836, and the like.

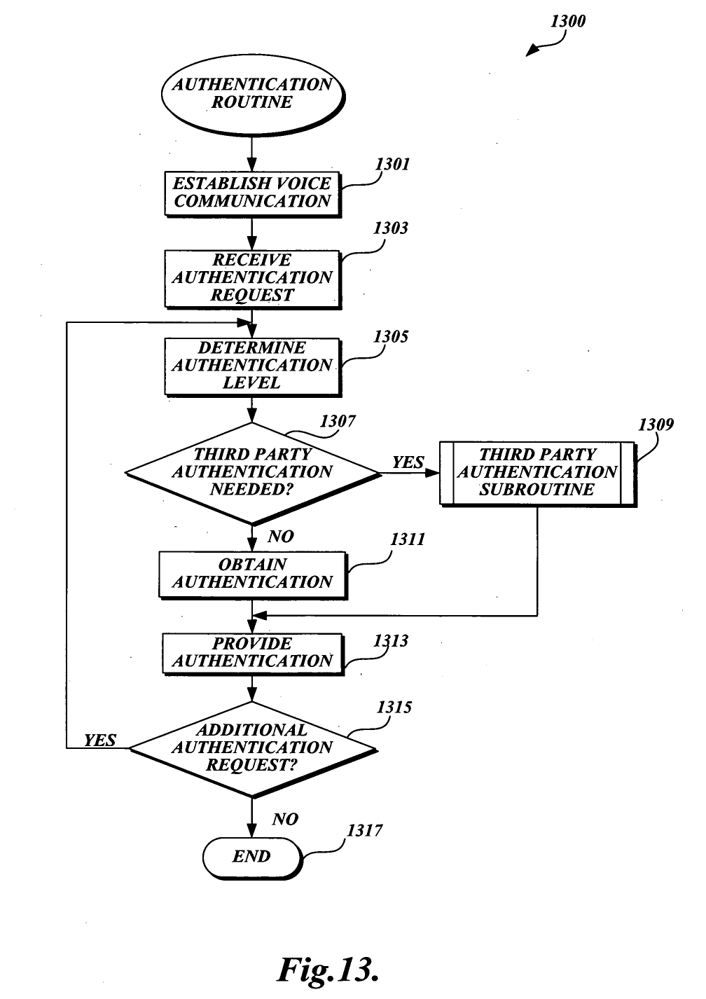

FIG. 13 is a flow diagram of an authentication routine for authenticating a contact point (e.g., an individual, company, etc.) participating in a digital voice conversation in accordance with an embodiment of the present invention. The authentication routine 1300 begins at block 1301 in which a voice conversation between two or more VoIP clients is established. At some point during establishment of a digital voice conversation or at any time thereafter, an authentication request may be received by one or more of the VoIP client devices, as illustrated by block 1303. As discussed above, an authentication request may be automatically generated as part of a voice conversation to periodically authenticate the contact points participating in the conversation. Alternatively, an authentication request may be received from active input from one of the contact points involved in the conversation or from a third-party monitoring or involved in the conversation.

At block 1305, upon receipt of an authentication request, the authentication level necessary to satisfy the request is determined. For example, if the authentication is simply an identity verification, voice recognition may be used for authenticating the contact point. However, if the authentication request is to confirm a transaction, a contact point's age, or some other item of information in which the authentication must be established to a higher degree of certainty, more than one authentication technique may be used. For example, voice authentication in combination with a digital signature may be used to further verify the validity of the authentication being received. Upon determination of the authentication level at block 1305, at decision block 1307 a determination is made as to whether third-party authentication is needed. As discussed above, third-party authentication may be necessary in which a third-party is required to approve the activity being conducted. For example, if the activity is the ordering of prescription drugs, authentication from the doctor (the third-party) may be necessary to complete the activity.

If it is determined at decision block 1307 that third-party authentication is needed, the third-party authentication subroutine, as illustrated by subroutine block 1309, is performed. However, if it is determined at decision block 1307 that third-party authentication is not needed, at block 1311 authentication is obtained from the contact point utilizing the VoIP client device that received the authentication request at block 1303. As discussed above, authentication of a contact point may be obtained using any typical authentication technique including, but not limited to, biometrics, passwords, digital signatures, etc. Once the authentication is obtained at block 1311, at block 1313 authentication information for the contact point is generated and provided to the entity that initiated the authentication request that was received at block 1303. The authentication information may be the same as the obtained authentication or may be some other information that confirms the identity of the contact point.

At decision block 1315, a determination is made as to whether additional authentication requests have been received by the VoIP client device. If it is determined at decision block 1315 that additional authentication requests have been received, the routine 1300 returns to block 1305 and continues. However, if it is determined at decision block 1315 that additional authentication requests have not been received, the authentication routine 1300 completes, as illustrated by block 1317.

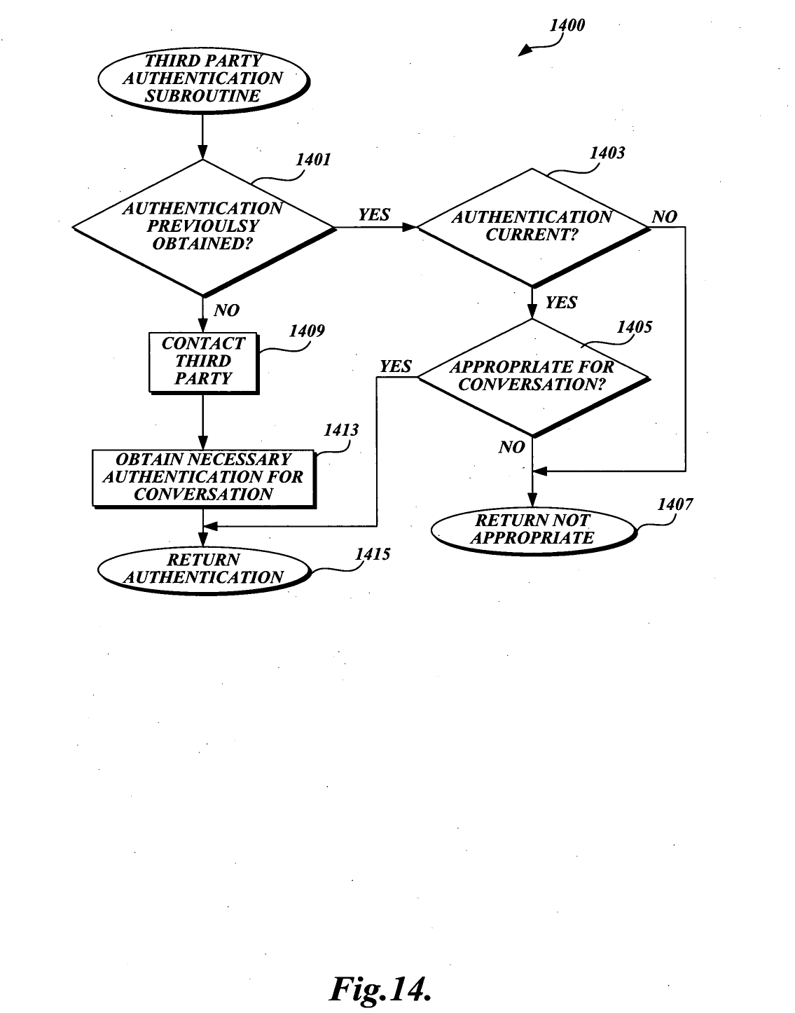

FIG. 14 is a flow diagram of a third-party authentication subroutine for obtaining authentication from a third-party to be used in connection with authentication of an existing digital voice conversation in accordance with an embodiment of the present invention. Third-party authentication is authentication received from any contact point not directly involved in the conversation. The third-party authentication subroutine may be performed by one of the clients as part of the authorization routine 1300 or independently by a service, or service provider, that monitors conversation for necessary authorization.

The third-party authentication subroutine 1400 begins at decision block 1401, in which a determination is made as to whether one of the contact points involved in the digital voice conversation has previously obtained the necessary third-party authentication (e.g., obtained authentication through delegation). In accordance with embodiments of the present invention, authentication may be delegated to different entities for a limited or particular use. For example, a doctor may delegate his authority to order prescription drugs to his/her nurse, or an automated system, for a one-time or a limited time use. For example, in a prior interaction between the doctor and the nurse/automated system in which the doctor is requesting the ordering of a prescription drug, the doctor may delegate his/her authentication ability for the purpose of ordering those prescription drugs. In one embodiment, delegation occurs by providing the entity to which the delegation is being given temporary authentication information for the delegating party, such as a temporary digital signature. The delegated temporary authentication information may also include details about what the authentication information may be used for and how long the delegation of that information is valid.

If it is determined at decision block 1401 that authentication information has previously been obtained, at decision block 1403 a determination is made as to whether the previously obtained authentication information is current. If it is determined at decision block 1403 that the previously obtained authentication information is current, at decision block 1405 it is determined whether the previously obtained authentication information is appropriate for the conversation. Determining appropriateness may be accomplished by identifying the extent or type of delegated information previously provided to one of the VoIP contact points and comparing that delegated information to the activity for which the authentication has been requested to confirm that they are consistent. If it is determined at decision block 1403 that the authentication is not current, or if it is determined at decision block 1405 that the delegated authentication is not appropriate for the existing activity at block 1405, the authentication subroutine 1400 completes at block 1407 and returns an identification that the third-party authentication is not appropriate or current. If the delegated authentication information is current and appropriate, the authentication information is returned at block 1415 and the subroutine completes.

Returning to decision block 1401, if it is determined that the authentication has not been previously obtained through delegation, at block 1409 the third-party from which the authentication is necessary is contacted. At block 1413 the necessary authentication for the conversation is obtained from the third-party and returned to the authentication routine 1300, as illustrated by block 1415. In providing authentication information, the third-party may review the conversation, activity, and/or the identity of the contact points involved in the conversation and provide authentication information using techniques similar to those described with respect to FIG. 13.

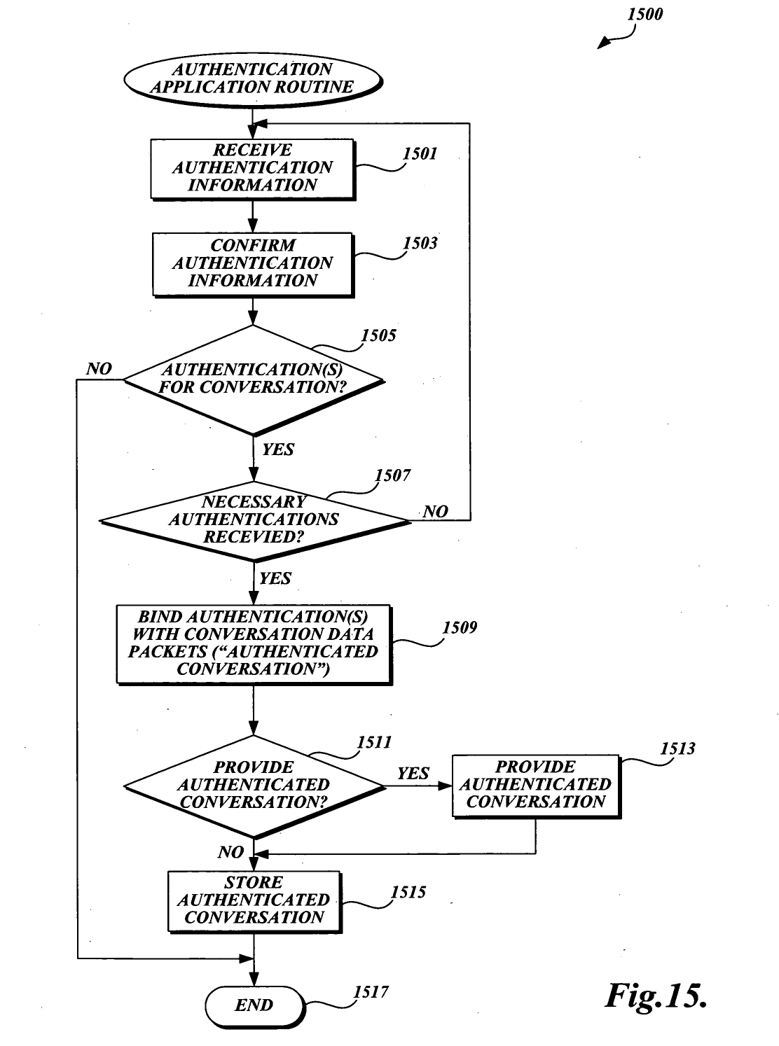

FIG. 15 is an authentication application routine for applying received authentication information to a digital voice conversation in accordance with an embodiment of the present invention. At block 1501, the authentication application routine 1500 receives authentication information from one or more VoIP entities involved or providing additional authentication for a digital voice conversation. At block 1503, the received authentication information is confirmed. For example, if the authentication is a periodic identity verification, it may be confirmed that the received authentication information matches the prior authentication information. At decision block 1505, a determination is made as to whether the authentication information is to be bound with part of the conversation. If it is determined at decision block 1505 that the received authentication information is to be bound with the conversation, at decision block 1507 a determination is made as to whether all the necessary authentication information for the conversation has been received. If it is determined at decision block 1507 that all the necessary authentication information has not been received, the routine 1500 returns to block 1501 and receives the remaining necessary authentication information that is needed. If it is determined at decision block 1507 that the necessary authentication information has been received, at block 1509 the received authentication information is bound with the conversation data packets to generate an authenticated conversation.

The binding of authentication information with conversation data packets may include binding the authentication information with all of the data packets for the entire conversation or only a portion of the data packets for that conversation. For example, during a conversation, one or more of the VoIP entities may activate and/or indicate that a particular segment of the conversation is to be captured and authenticated. Such an event may identify to one or more of the VoIP entities that authentication information is needed, thereby initiating the authentication routine 1300, and the authentication application routine 1500, resulting in the binding and creation of authenticated conversation.

At decision block 1511, a determination is made as to whether the authenticated conversation is to be provided to one or more of the VoIP clients or to a third-party. If it is determined at decision block 1511 that the authenticated conversation is to be provided to one or more of the VoIP clients and/or a third-party, at block 1513 the authenticated conversation is appropriately provided. However, if it is determined at decision block 1511 that the authenticated conversation is not to be provided, or after the authenticated conversation is provided at block 1513, at block 1515 the authenticated conversation is stored. The authentication application routine 1500 completes, as illustrated by block 1517.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for authenticating a contact point that is participating in a digital voice communication, comprising:
receiving an authentication request;
obtaining an authentication from the contact point;
confirming an identity of the contact point based on the received authentication; and
providing the authentication in the form of authentication information.

2. The method of claim 1, wherein the obtained authentication is based on biometrics.

3. The method of claim 1, wherein the obtained authentication is a digital signature of the contact point.

4. The method of claim 1, wherein the obtained authentication includes both biometrics and a digital signature.

5. The method of claim 1, further comprising:
determining if third-party authentication is needed; and
if it is determined that third-party authentication is needed, determining if third-party authentication information has been delegated to the contact point.

6. The method of claim 5, wherein if it is determined that third-party authentication information has been delegated, determining if the third-party authentication information is current.

7. The method of claim 5, wherein if it is determined that third-party authentication information has been delegated, determining if the third-party authentication information is appropriate.

8. The method of claim 1, wherein the authentication information is used to associated the contact point with at least a portion of the digital voice conversation.

9. A computer-readable medium having computer-executable components for authenticating contact points and digital voice conversations, comprising:
an authentication request component for generating authentication requests that are issued to at least one contact point involved in a digital voice conversation;
an authentication collection component for collecting an authentication from at least one contact point involved in a digital voice conversation; and
an authentication application component for applying the authentication to the digital voice communication.

10. The computer-readable medium of claim 9, wherein an authentication request is periodically generated to confirm an identity of at least one of the contact points involved in the digital voice conversation.

11. The computer-readable medium of claim 9, wherein an authentication request is generated in response to input from a contact point involved in the digital voice communication.

12. The computer-readable medium of claim 9, wherein the authentication collection component determines if authentication from a third-party is necessary; and
if it is determined that authentication is necessary, the authentication request component determines if third-party authentication has been delegated to at least one of the contact points involved in the digital voice communication.

13. The computer-readable medium of claim 12, wherein if it is determined that the third-party authentication has been delegated to at least one of the contact points, the authentication request component issues a request to the at least one contact point for delegated authentication information.

14. The computer-readable medium of claim 12, wherein if it is determined that third-party authentication has not been delegated to at least one of the contact points, the authentication request component contacts the third-party and issues a request to the third-party for authentication.

15. The computer-readable medium of claim 12, wherein third-party authentication is necessary to approve an activity that is conducted as part of the digital voice communication.

16. The computer-readable medium of claim 9, wherein applying the authentication includes:
determining if necessary authentications for the conversation have been collected; and
if it is determined that necessary authentications have been collected, binding at least a portion of the digital voice conversation with the collected authentications.

17. A method for generated an authenticated conversation, comprising:
receiving authentication information from at least one contact point involved in a digital voice conversation;
collecting a plurality of data packets from the digital voice conversation; and
binding the received authentication information with the plurality of data packets to generate an authenticated conversation.

18. The method of claim 17, wherein conversation contained in the plurality of data packets relates to an activity in which contact points involved in the activity need to be authenticated and associated with the activity.

19. The method of claim 18, wherein the contact points include at least one contact point directly involved in the digital voice conversation and at least one contact point not directly involved in the digital voice conversation.

20. The method of claim 18, wherein the authenticated conversation is stored.
